(19) United States
(12) Patent Application Publication
(10) Pub. No.: US 2020/0151560 A1
(43) Pub. Date: May 14, 2020

(54) APPARATUS AND METHODS FOR USING BAYESIAN PROGRAM LEARNING FOR EFFICIENT AND RELIABLE GENERATION OF KNOWLEDGE GRAPH DATA STRUCTURES

(71) Applicant: Silot Pte. Ltd., Singapore (SG)

(72) Inventors: Zihao SONG, Singapore (SG); Ji Ll, Singapore (SG)

(73) Assignee: Silot Pte. Ltd., Singapore (SG)

(21) Appl. No.: 16/543,186

(22) Filed: Aug. 16, 2019

(30) Foreign Application Priority Data
Nov. 9, 2018 (SG) 10201809980V

(51) Int. Cl. G06N 3/08; G06N 3/04; G06F 16/901

(52) U.S. Cl. CPC G06N 3/08; G06F 16/9024; G06N 3/0472

(57) ABSTRACT

In some embodiments, an apparatus includes a memory and a processor operatively coupled to the memory. The processor can be configured to receive multiple heterogeneous data records from at least one data source. The processor is configured to extract a set of features from the multiple data records, and to normalize the extracted set of features. The processor is configured to selectively combine the extracted set of features to define entity records. The processor is configured to associate two or more entity records to form relationships that have an indication of relation type and an indication of relation likelihood. In some embodiments, the processor can be configured to generate a knowledge graph data structure on the entity records and relationships.

### CROSS REFERENCE TO RELATED APPLICATION

This application claims priority to and the benefit of Singapore Patent Application No. 10201809980V, filed Nov. 9, 2018 and titled “Apparatus and Methods for Using Bayesian Program Learning for Efficient and Reliable Construction of Knowledge Graph Data Structures,” which is incorporated herein by reference in its entirety.

### TECHNICAL FIELD

The present disclosure generally relates to the field of information technologies, and in particular to methods and apparatus for efficient and reliable generation of knowledge graph data structures.

BACKGROUND

Knowledge graph data structures are efficient tools for organizing data into a meaningful representation of contents of that data, by providing a common interface for the data, and enabling generation of relations throughout the data. Some known approaches for generating knowledge graph data structures are, for example, purely rule-based. Such approaches, for example, use human experts to define rules for specific cases and then implement the rules on data records. While these approaches might work for very specific cases and/or domains, it becomes increasingly costly in terms of time and resources when there are many different cases and/or domains. Each case can involve ad hoc analysis. Reconciling differences and commonalities for such cases can be costly and take trial and error to reach a desired accuracy, for example, a human-level performance accuracy.

Some known approaches for generating a knowledge graph data structure are, for example, based on deep learning. It, however, can be costly to generate the training data for generating a knowledge graph data structure. Specifically, generating a knowledge graph data structure can be much more complex than a typical deep learning task. To reach a desired accuracy, for example, a human-level performance accuracy, data-driven approaches can involve using a large amount of data. Moreover, the end result can still have reliability issues because data-driven approaches are statistical approximations and can include unreasonable assumptions.

Some known approaches for generating a knowledge graph data structure are, for example, based on a combination of ruled-based approaches and data-driven approaches. While such approaches can mitigate efficiency issues to some extent for some cases, this can often do so at the cost of reliability.

Thus, a need exists for improved methods and apparatus, to overcome the aforementioned efficiency and reliability limitations in known knowledge graph data structure generation methods.

### SUMMARY

In some embodiments, an apparatus includes a memory and a processor operatively coupled to the memory. The processor can be configured to receive multiple heterogeneous data records from at least one data source. The processor is configured to extract a set of features from the multiple data records, and to normalize the extracted set of features. The processor is configured to selectively combine the extracted set of features to define entity records. The processor is configured to associate two or more entity records to form relationships that have an indication of relation type and an indication of relation likelihood. In some embodiments, the processor can be configured to generate a knowledge graph data structure on the entity records and relationships.

### BRIEF DESCRIPTION OF THE DRAWINGS

FIG. 1 is a schematic block diagram of a system to generate a knowledge graph data structure from data, according to an embodiment.

FIG. 2 is a diagram illustrating a method of generating a knowledge graph data structure from data records, according to an embodiment.

FIG. 3 is a flowchart illustrating a method for generating a knowledge graph data structure from a set of data sources, according to an embodiment.

FIG. 4 is a diagram showing an example output from an entity program, according to an embodiment.

FIG. 5 is a diagram showing an example output from a relation program, according to an embodiment.

FIG. 6 is a diagram showing a system for generating a knowledge graph data structure, according to an embodiment.

FIG. 7 is a diagram showing a system for generating a knowledge graph data structure, according to an embodiment.

### DETAILED DESCRIPTION

In some embodiments, a non-transitory processor-readable medium stores code representing instructions to be executed by a processor. The code includes code to cause the processor to extract a set of data records from at least one data source. The code includes code to cause the processor to combine, using a first set of predefined rules having parameters trained using a first Bayesian Program Learning (BPL) model, a set of data records into a single data record based on a likelihood that each data record from the set of data records is associated with a common entity record. The code includes code to cause the processor to define a link, using a second set of predefined rules having parameters trained using a second BPL model, between the single data record and at least one other data record from the set of data records. The code includes code to cause the processor to define and/or generate a knowledge graph data structure that represents a set of links including the link defined by the second BPL model. The code includes code to cause the processor to detect, based on the set of links, a set of attributes associated with the common entity record.

In some embodiments, a method includes receiving multiple heterogeneous data records from at least one data source; the heterogeneous data include at least one of structured data, semi-structured data, or unstructured data. The method further includes preparing multiple prepared data records using feature extraction and normalization implemented in a processor of a compute device. The method further includes defining, by sampling data from the empirical distribution of the prepared data records and merging a first prepared data record from the multiple prepared data records with the second prepared data record from the multiple prepared data records, based on comparing the sampled data with multiple predefined quality criteria. The method further includes associating two entity records based on an indication of relation type and an indication of relation likelihood between the two entity records. The method further includes generating a knowledge graph data structure based on the multiple entity records and the established associations between those entity records.

In some embodiments, an apparatus includes a memory and a processor operatively coupled to the memory. The processor can be configured to receive multiple heterogeneous data records from at least one data source. The processor is configured to extract a set of features from the multiple data records, and to normalize the extracted set of features. The processor is configured to selectively combine the extracted set of features to define entity records. The processor is configured to associate two or more entity records to form relationships that have an indication of relation type and an indication of relation likelihood. In some embodiments, the processor can be configured to generate a knowledge graph data structure on the entity records and relationships.

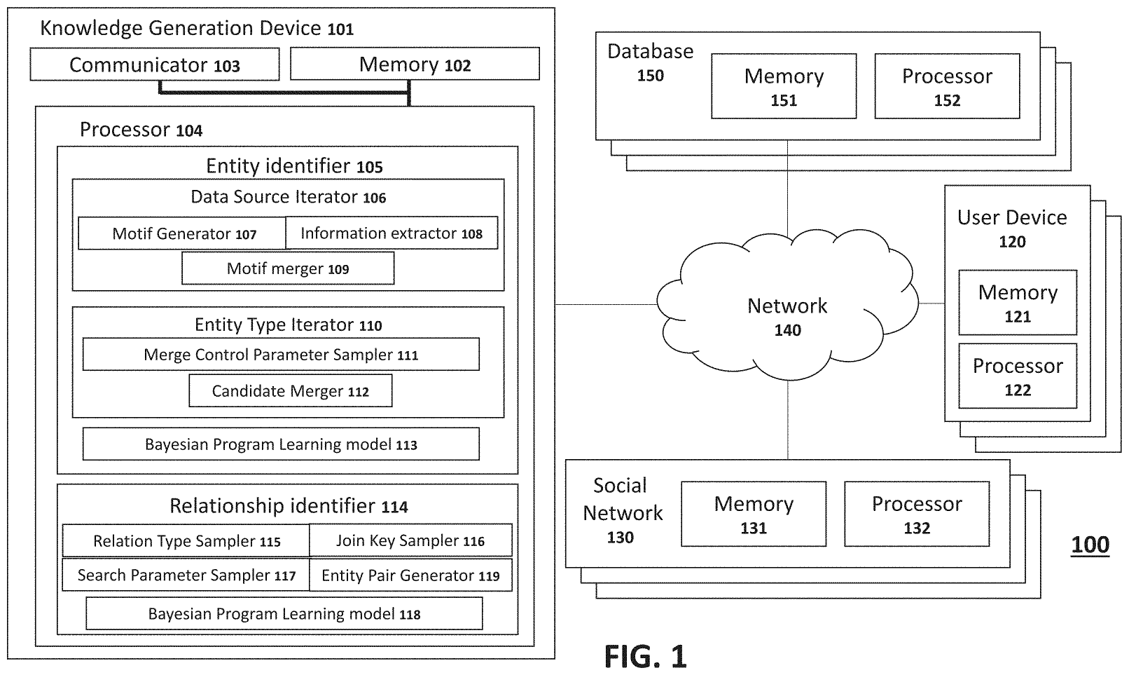

While the methods and apparatus are described herein as processing heterogeneous data and/or generating a knowledge graph data structure from the heterogeneous data, in some instances a knowledge generation device (such as knowledge generation device 101 of FIG. 1) can be used to process and/or generate any collection or stream of artifacts, events, objects, and/or data. As an example, a knowledge generation device can process and/or generate an artifact such as, for example, any string(s), number(s), name(s), address(es), telephone number(s), bank account number(s), social security number(s), email address(es), occupation(s), image(s), audio(s), video(s), portable executable file(s), dataset(s), Uniform Resource Locator (URL), device(s), device behavior, and/or user behavior. For further examples, an artifact can include a function of software code, a webpage(s), a data file(s), a model file(s), a source file(s), a script(s), a process, a binary executable file(s), a table(s) in a database system, a development deliverable(s), an active content(s), a word-processing document(s), an e-mail message(s), a text message, bank account information, a handwritten form(s), and/or the like. As another example, a knowledge generation device can process streams including, for example, video data, image data, audio data, textual data, and/or the like.

FIG. 1 is a schematic block diagram of a Knowledge Generation Device 101 connected, via a network 140 to databases 150, user devices 120, and social networks 130, and used to generate a knowledge graph data structure from a data source, according to an embodiment. The data source can include homogeneous data or heterogeneous data. The homogeneous data can be made up of things that are similar to each other, for example, a list of names of students of a university. Heterogeneous data can be data that is not similar to other data and/or originates from different sources. The data can include at least one of structured data, semi-structured data, or unstructured data. Structured data can include a standardized format for providing information, for example, a list of automatic teller machine (ATM) transactions stored in a database file and/or in a CSV file. Unstructured data can include information that is not organized in a pre-defined manner, for example, text messages, and contents of emails and/or websites in an HTML file. Semi-structured data can include information that have some organizational properties but are not stored in a standardize format, for example, data found in an XML, or JSON file. The knowledge generation device 101, also referred to herein as “the knowledge graph device” or “the device”, can be a hardware-based computing device and/or a multimedia device, such as, for example, a compute device, a server, a desktop compute device, a smartphone, a tablet, a wearable device, a laptop and/or the like. The knowledge generation device 100 includes a memory 102, a communicator 103, and a processor 104.

The processor 104 can be, for example, a hardware based integrated circuit (IC) or any other suitable processing device configured to run and/or execute a set of instructions or code. For example, the processor 104 can be a general purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. The processor 104 is operatively coupled to the memory 102 through a system bus (for example, address bus, data bus and/or control bus).

The processor can include an entity identifier 105 (also referred to herein as “entity program”) and a relationship identifier 114 (also referred to herein as “relation program”). Each of the entity identifier 105, and the relationship identifier 114, can be software stored in memory 102 and executed by processor 104 (e.g., code to cause the processor 104 to execute the entity identifier 105 and/or the relationship identifier 114 can be stored in the memory) and/or a hardware based device such as, for example, an ASIC, and FPGA, a CPLD, a PLA, a PLC and/or the like. The processor can be configured to receive and/or to define a set of concept types, a set of entity types, and/or a set of relation types. The set of concept types (e.g., publicly listed companies, private companies, humans, banks, etc.) is a list of terms that serve as semantic schema for the set of entity types (e.g., organization, person, place, etc.) and the set of relation types (e.g., a founder of, an employee of, a substantial shareholder of, a friend of, an owner of, etc.), and is used to determine the format of entity records and relationships generated by apparatus and methods described in further details herein. The entity identifier 105 generates the set of entity types using the set of concept types and the data. Similarly, the relationship identifier 114 generates a set of relation types using the set of concept types and the data.

The entity identifier 105, can be configured to have a data source iterator 106 and an entity type iterator 110, as described in further detail here. The entity identifier 105 can be configured further to return and/or identify a set of extracted information from the data using the data source iterator 106. The entity identifier 105 can be configured further to return a set of entities generated by the entity type iterator 110.

The data source iterator 106 can be configured to have a motif generator 107, an information extractor 108, and a motif merger 109, as described in further detail herein. The data source iterator 106 can be configured to iteratively receive a set of data records from one or more data sources at the motif generator 107. The data source can be a memory, a website, a server, a sensor, a device and/or the like, from which the set of data records are derived and/or in which the set of data records is stored. In some instances, the data source can include at least one of a database, a file system, an application, a website, and/or the like. The data source can be the local knowledge generation device 101 and/or an external database 150, a user device 120, and/or a social network 130 connected to the knowledge generation device 101 via a network 140. The motif generator 107 can be configured to conduct regulatory element analysis to identify regularly appearing patterns with statistical significance in the set of data records of the set of data sources, and/or generate motifs (e.g., a common pattern to represent an entity, a type of candidate, and/or attribute, such as, for example, ten consecutive digits representing phone numbers, reoccurring pattern of letters ‘c’, ‘a’, and ‘t’ representing a cat, and/or the like) using motif discovery algorithms (e.g., Gibbs sampler algorithm, repulsive parallel Markov chain Monte Carlo, and/or the like). The motifs of the set of data records can be configured to be generated by a feature extractor that captures the schema and metadata of the data records. The information extractor 108 samples each data record from the set of data sources, based on the motifs and the set of concept types, to transform each data record into a set of candidates. The information extractor 108 is configured to select at least one extraction and transformation rule from a set of predefined rules, for example, from a library of extraction and transformation rules, to apply to each of the sampled data to determine to retain or to discard the sampled data. The motif merger 109, merges the motifs into a set of motifs to be used in the entity type iterator 110.

The information extractor 108 can be configured to receive a set of data records and/or a set of motifs as an input and prepare a set of prepared data, also referred to as a set of candidates. More specifically, in some implementations, the information extractor 108 identifies features in the set of data records (for example, strings, numbers, names, addresses, telephone numbers, bank account numbers, social security numbers, email addresses, occupation, images, audios, videos, and/or the like). The information extractor 108 can be configured, for example, to represent the identified features as a feature vector. For example, the information extractor 108 can normalize each feature and/or input each feature to a common scale. Normalization can also be putting data records into a common format. The information extractor 108, using the common scale, can form feature vectors, for example, with pre-determined length and/or numerical range.

As an example, in some implementations, the information extractor 108 can be configured to extract features of a spreadsheet data such as a spreadsheet processing software file (e.g., an ‘.xls’ and/or a ‘.gnumeric’ file). The features can, for example, include internal representations of the document (e.g., text streams, numerical data, dates, pivot chart, references, formulas, embedded Visual Basic Application (VBA) code, and/or metadata associated with the spreadsheet processing software file). The information extractor 108 can then, for example, tokenize the extracted features into printable strings by not including XML, delimiting characters (‘<’ or ‘>’), removing any length less than a specified length (e.g., 5 characters) and/or other tokenizing techniques. The information extractor 108 can then provide each feature as an input to a hash function to generate a hash value for that feature. The information extractor 108 can use the normalized values to a common scale to form a feature vector representative of and/or indicative of the features in the spreadsheet processing software file.

The entity type iterator 110 can be configured to have a merge control parameter sampler 111 and a candidate merger 112, as described in further detail herein. The merge control parameter sampler 111 can be configured to sample candidates from an empirical distribution of the set of candidates to generate a set of control parameters. The set of control parameters can specify the qualifying criteria for merging multiple candidates from the set of candidates. The qualifying criteria can include a set of potential merge keys to compare the confidence level of the dataset and/or to compare the threshold of similarity that qualifies for merging (e.g., common name of a person, common identification number, etc.). The candidate merger 112 can be configured to compare different sets of candidates and decide whether the candidates correspond to a common entity based on the set of entity types and the set of motifs. The entity type iterator 110 can be configured further to iterate over the elements of the set of the entity types to execute the merge control parameter sampler 111 and the candidate merger 112 to generate the set of entities. The set of candidates after merging by the candidate merger 112 to a set of entity records are referred to as attributes of entity records. The entity identifier 105 can be configured further to generate a set of model parameters as a BPL model 113. The set of model parameters including, but not limited to, the set of control parameters.

The relationship identifier 114 can include a BPL model 118, a relation type sampler 115, a join key sampler 116 , a search parameter sampler 117, and an entity pair generator 119, as described in further detail herein. The relation type sampler 115 can be configured to generate the set of relation types based on the set of concept types. The join key sampler 116 can be configured to generate a set of join keys based on an empirical likelihood, using the set of concept types and/or the set of relation types. The search parameter sampler 117 can be configured to sample search parameters based on the set of join keys to generate the set of search parameters. The entity pair generator 119 can be configured to generate entity pairs based on at least one pair in the set of search parameters and associate a relation type from the set of relation types, and a relation likelihood, to each entity pair from the entity pairs. The relationship identifier 114 can be configured to generate the set of relationships from the generated entity pairs and their associated relation type.

The BPL models 113 and 118 can be trained to perform one or more tasks such as, for example, optimizing an inference algorithm-based model parameters to perform entity identification and/or relationship identification. The BPL model 113 and/or 118 includes a set of model parameters that can generate a set of entity records and the set of relationships from the set of data sources, using the inference algorithm. The BPL model 113 can be trained to identify the set of entity records and the BPL model 118 can be trained to identify a set of relationships from the set of entities in the set of data sources. The knowledge generation device 101 using the trained BPL model can be configured to generate a knowledge graph data structure. More generally, in accordance with an embodiment, the knowledge graph data structure can be a graphical model defined by the BPL models 113 and/or 118 to demonstrate conditional dependencies between randomly sampled data records form the set of data sources.

The memory 102 of the knowledge generation device 101 can be, for example, a random access memory (RAM), a memory buffer, a hard drive, a read-only memory (ROM), an erasable programmable read-only memory (EPROM), and/or the like. The memory 102 can store, for example, one or more software modules and/or code that can include instructions to cause the processor 104 to perform one or more processes, functions, and/or the like (e.g., the information extractor 108, the entity identifier 105, the relationship identifier 114). In some implementations, the memory 102 can be a portable memory (e.g., a flash drive, a portable hard disk, and/or the like) that can be operatively coupled to the processor 104. In other instances, the memory can be remotely operatively coupled with the knowledge generation device. For example, a remote database 150 server can be operatively coupled to the knowledge generation device in a network 140.

The memory 102 can store BPL model data and a set of files. The BPL model data can include data generated by the BPL model during generation of a knowledge graph data structure (e.g., temporary variables, return addresses, and/or the like). The BPL model data can also include data used by the BPL model to process and/or analyze data (e.g., the set of control parameters, the set of entity type, the set of motifs, the set of relation types, the set of join keys, the set of search parameters, and/or other information related to the BPL model).

The communicator 103 can be a hardware device operatively coupled to the processor 104 and memory 102 and/or software stored in the memory 102 and executed by the processor 104. The communicator 103 can be, for example, a network interface card, a Wi-Fi™ module, a Bluetooth® module, an optical communication module, and/or any other suitable wired and/or wireless communication device. Furthermore, the communicator 103 can include a switch, a router, a hub and/or any other network device. The communicator 103 can be configured to connect the knowledge generation device 101 to a network 140. In some instances, the communicator 103 can be configured to connect to a communication network such as, for example, the internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof.

In some instances, the communicator 103 can facilitate receiving and/or transmitting a data record through a network 140. More specifically, in some implementations the communicator 103 can facilitate receiving and/or transmitting BPL model data through a network from and/or to a set of user devices 120 and/or from and/or to a set of databases 150 and/or from and/or to a set of social networks 130, each communicatively coupled via a network 140. The network 140 can be the internet, an intranet, a local area network (LAN), a wide area network (WAN), a virtual network, any other suitable communication system and/or a combination of such networks. In some instances, received data can be processed by the processor 104 and/or stored in the memory 102 as described in further detail herein.

The set of databases 150 are databases, such as external hard drives, database cloud services, external compute device, virtual machine images, and/or the like. The set of databases 150 each having a memory 151 and/or a processor 152. The processor 152 can be, for example, a hardware based integrated circuit (IC) or any other suitable processing device configured to run and/or execute a set of instructions or code. For example, the processor 152 can be a general purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. The processor 152 is operatively coupled to the memory 151 through a system bus (for example, address bus, data bus and/or control bus). The memory 151 can be, for example, random access memory (RAM), memory buffers, hard drives, databases, erasable programmable read only memory (EPROMs), electrically erasable programmable read only memory (EEPROMs), read only memory (ROM), flash memory, hard disks, floppy disks, cloud storage, and/or so forth. The set of databases can be configured to communicate with the knowledge generation device 101 via a network 140.

The set of user devices 120 are compute devices, such as personal computers, laptops, smartphones, or so forth, each having a memory 121 and a processor 122. The processor 122 can be, for example, a hardware based integrated circuit (IC) or any other suitable processing device configured to run and/or execute a set of instructions or code. For example, the processor 122 can be a general purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. The processor 122 is operatively coupled to the memory 121 through a system bus (for example, address bus, data bus and/or control bus). The memory 121 can be, for example, random access memory (RAM), memory buffers, hard drives, databases, erasable programmable read only memory (EPROMs), electrically erasable programmable read only memory (EEPROMs), read only memory (ROM), flash memory, hard disks, floppy disks, cloud storage, and/or so forth. The set of user devices 120 can be configured to communicate with the knowledge generation device 101 via a network 140.

The set of social networks 130 are servers and/or compute devices associated with social media services, such as Facebook, Youtube, LinkedIn, Twitter, and/or the like. The set of social networks 130 each having a memory 131 and/or a processor 132. The processor 132 can be, for example, a hardware based integrated circuit (IC) or any other suitable processing device configured to run and/or execute a set of instructions or code. For example, the processor 132 can be a general purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. The processor 132 is operatively coupled to the memory 131 through a system bus (for example, address bus, data bus and/or control bus). The memory 131 can be, for example, random access memory (RAM), memory buffers, hard drives, databases, erasable programmable read only memory (EPROMs), electrically erasable programmable read only memory (EEPROMs), read only memory (ROM), flash memory, hard disks, floppy disks, cloud storage, and/or so forth. The set of social networks 130 can be configured to communicate with the knowledge generation device 101 via a network 140.

In use, the processor 104 included in the knowledge generation device 101, can be configured to use the communicator 103 to retrieve a set of data records from a set of data sources (e.g., databases 150, user devices 120, social networks 130, and/or the like) over the network 140. The memory 102 can be configured to save the set of data records and, if applicable, a previously generated knowledge graph data structure. The processor 104 can be configured to further save the retrieved set of data records to the memory 102 of the knowledge generation device 101. The data source iterator 106, included in and/or executed by the processor 104, can be configured to receive the set of data records, extract a set of motifs from the set of data records using the motif generator 107, extract a set of candidates from the set of motifs and/or the set of data records using information extractor 108, and merge the set of motifs using the motif merger 109. The set of data records, the set of motifs, and/or the set of candidates can be stored in the memory 102. The entity identifier 105 and/or to the relationship identifier 114, included in and/or executed by the processor 104, can be configured to receive the stored set of data records, the set of motifs, and/or the set of candidates from the memory 102. The entity identifier 105 and/or the relationship identifier 114 can be configured to analyze the data using the entity type iterator 110, merge control parameter sampler 111, candidate merger 112, relationship identifier 114, relation type sampler 115, join key sampler 116, search parameter sampler 117, and/or entity pair generator 119, to generate a new knowledge graph data structure and/or to determine a placement of feature vectors among entities and relationships of the previously generated knowledge graph data structure, and/or update the BPL model 113 and/or the BPL model 118. The processor 104 can be configured to store the determined knowledge graph data structure in the memory 102.

As described herein, it is understood that a knowledge generation device (similar to knowledge generation device 101 shown and described with respect to FIG. 1) can include one or more BPL models (i.e., the BPL model 113 and/or the BPL model 118) that can be trained to generate a knowledge graph data structure from data sources that can include structures, semi-structured, and/or unstructured data records. A knowledge generation device can implement the methods described herein to receive a data record, extract information and features form the data records, and use the extracted set of features to identify entities in the data records by implementing an entity identifier (such as the entity identifier 105), and use the set of identified entities to build relationships between pairs of entities by implementing a relationship identifier (such as the relationship identifier 114). The entity identifier and relationship identifier each can include a BPL model (i.e., the BPL model 113 and/or the BPL model 118) to infer entities and relationships by sampling through the data extracted, by the information extractor 108, from the data source.

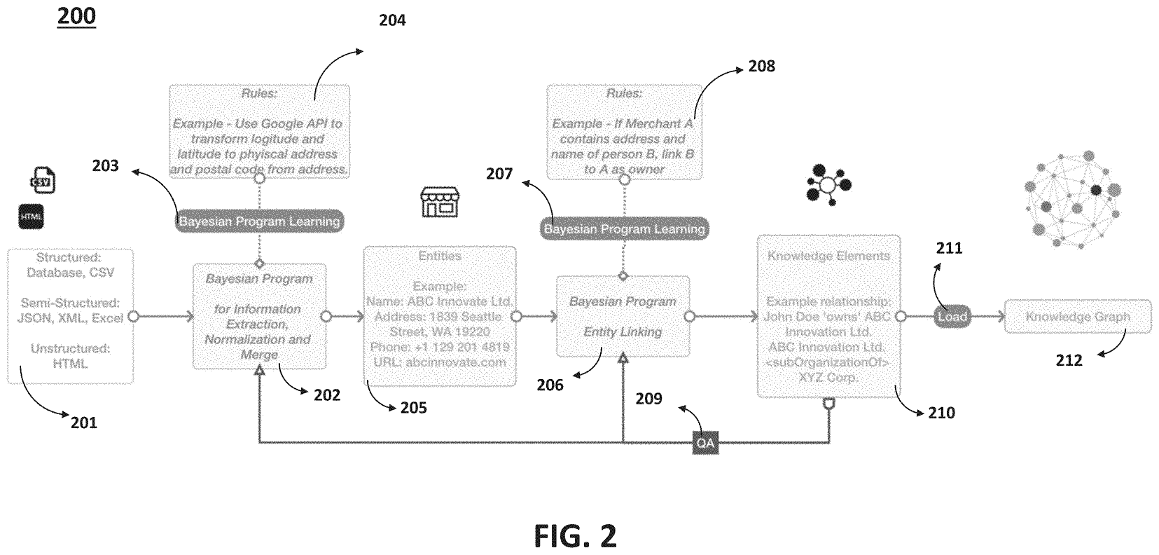

FIG. 2 is a diagram illustrating a method 200 of generating a knowledge graph data structure at 212 using a set of data records at 201, according to an embodiment. The method 200 can be substantially similar to the operation of the knowledge generation device described above with respect to the device 101. The method 200 can include identifying an entity record at 202 and identifying a relationship at 206. Identifying an entity record at 202 can involve extracting information and using a first BPL model at 203 to generate a set of entity records at 205. For example 204, identifying entity records at 202 can involve receiving a set of data including a longitude and latitude data and generating and using a first BPL model at 203 to generate a physical address and a postal code from the longitude and latitude data. Identifying relationships at 206 can involve using a second BPL model at 207 to generate a set of entity pairs (also referred to herein as “knowledge elements”) at 210. For example 208, identifying relationships at 206 can involve receiving a data record of person B, and a data record of property A including the name of person B, generating a second BPL model at 207 to generate a set of knowledge elements at 210 that links person B as the owner of property A. The method 200 can include using a load mechanism at 211 to generate the knowledge graph data structure at 212 by storing the set of entity records generated at the method step at 205 and the set of knowledge elements generated at the method step at 210. The method 200 can further include auditing at 209 the correctness of each knowledge element of the set of knowledge elements at 210 to update the BPL models at 203 and/or at 207.

At 202, a set of entity records 205 can be generated by training the first BPL model 203. At 202, the set of data records are prepared by extracting information, normalizing the extracted information, and/or merging extracted and/or normalized information using the set of data records (e.g., CSV, HTML, JSON, XML data 201). To extract information, the method 200 samples each data source from the set of data sources to transform each data source into a set of candidates. To identify entity records 202, a set of predefined rules, for example, a library of extraction and transformation rules is configured to perform extraction of a set of candidates. Identifying entity records 202 can further include, for example, normalizing each extracted information and/or by inputting each feature to a common scale. Identifying entity records 202 can further include merging the extracted and/or normalized set of candidates using a merge function that compares different subsets of the set of candidates and determine, using the first BPL model 203 and a set of control parameters, whether the subsets of candidates belong to the same entity. The method step 202, further includes forming a set of entities 205 from the subsets of entity records that are determined to belong to the same entity record.

At 206, a set of relationships can be generated by training the second BPL model 207 to sample from a set of relation types, a set of join keys and/or a set of search parameters, and to generate a set of entity pairs. At 206, the set of relation types can be generated based on the concept types. At 206, the set of join keys can be generated using the set of concept types and the set of relation types. For example, join keys for the relation type “a substantial shareholder of” can be the name and/or an identification number associated with the name of an “organization”, an indication of shares associated to a “person”, a list of names and indication of shares associated to a company, and/or the like. At 206, the set of search parameters can be generated using a set of join keys. For example, the search parameter can be an indication of similarity and/or difference between the strings of names of “shareholders”, absolute numerical difference of number of shares associated to an “organization”, and/or the like. If the indication of similarity and/or difference between two entities is above a pre-determined threshold, the two entities can be paired to generate an entity pair. At 206, the set of entity pairs are generated based on the set of join keys, the set of search parameters, and/or the second BPL model 207. The set of entity pairs can be associated to a relation type from the set of relation types, and a relation likelihood. The relation type and the relation likelihood for each pair from the set of pairs can be described by a normalized numerical value, a string, a latent space embedding, and/or the like. The method step 206, can further include forming a set of relationships 210 using the set of entity pairs that are associated with a relation type.

At 209, a set of results can be received from at least one of the results of identifying the set of entities 205, identifying the set of relationships 210, or generating knowledge graph data structure 212. To audit the set of results 209, each result from the set of results can be displayed to users to be approved or disapproved. In an embodiment, the approved set of results and/or the disapproved set of results are stored to a data storage for future use. The approved set of results and/or the disapproved set of results can be used to update, for example, a subset of relationships and/or a subset of entities to generate a set of updated entities and/or a subset of updated relationships. The set of updated relationships and the set updated entities can be used to regenerate the knowledge graph data structure 212, and/or to further train the BPL models at 203 and/or 207.

Extracting information to identify entity records 202 can be performed by the feature extraction methods using at least one of an isomap, a principal component analysis (PCA), a kernel principal component analysis (kernel PCA), an artificial neural network (ANN), a thresholding, a connected-component labeling and/or the like on the data records of the set of data sources 201. The isomap or isometric feature mapping is a dimensionality reduction approach for feature extraction that can be used, for example, to preserve the intrinsic geometry of the data record. Dimensionality reduction approaches can be used, for example, to find meaningful low-dimensional structures hidden in the original high-dimensional data record from the set of data sources 201. The PCA can be use, for example, to convert a set of potentially correlated data records into a set of uncorrelated data records called principal components. The kernel PCA can maximize the variance in the data records that were mapped to a higher dimensional space via a function. The ANN can be used, for example, to map the data record to a meaningful lower dimensional and/or a higher dimensional representation of the data record. The thresholding can be used, for example, to remove unwanted data, for example, a noise in a time series data. The connected-component labeling can be used, for example, to distinguish candidates in the data records from the set of data sources 201.

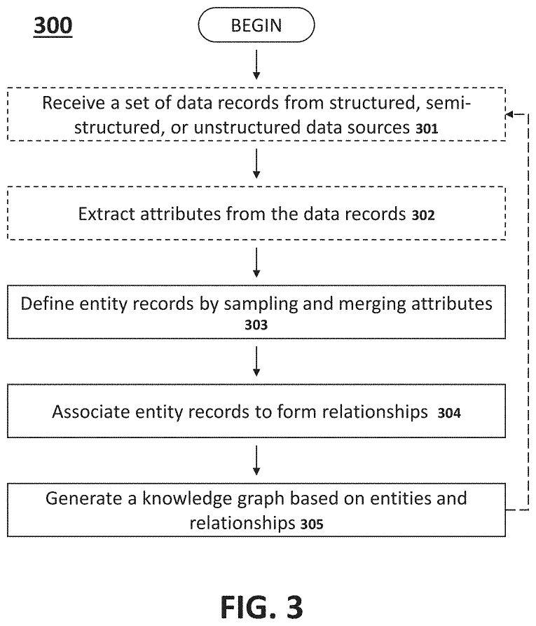

FIG. 3 is a flowchart illustrating a method 300 for generating a knowledge graph data structure from a set of data sources, according to an embodiment. As shown in FIG. 3, the method 300 optionally includes receiving, at 301 and via a processor, a set of data records from at least one of a set of structured data sources, a set of unstructured data sources, or a set of semi-structured data sources. The method 300 includes extracting, at 302 and via a processor, a set of information from the set of data records. At 303, a set of entity records are defined by sampling from the set of information and merging correlated information. The method step 303 can be performed by an entity program. The defined set of entity records are associated with one another, at 304, to define a set of relationships between the elements of the set of entity records. The method step 304 can be performed by an entity program. A knowledge graph data structure is generated, at 305 and via a processor, to represent the set of entity records and the set of relationships between the set of entity records.

An example of a procedure for defining a set of entity records from the set of information (e.g., conducted at step 303 of method 300 by, for example, an entity program) is as follows:

| Definition | |
|---|---|
| Xᵢ: the i-th dataset | |
| zᵢ: the motif of Xᵢ | |
| Hᵢ: the set of candidates extracted from Xᵢ | |
| Procedure Entity Program | |
| For i = 1,...,k do | iterate different data sources |
| zᵢ ← ϕ(Xᵢ) | generate dataset motif |
| fᵢ ← P (f\|λ, zᵢ) | sample extraction function |
| Hᵢ ← fᵢ(Xᵢ) | generate candidates |
| Z ← {z₁,...,zₖ} | merge motifs |
| For i = 1,...,m_{λ} do | iterate entity type |
| θᵢ ← P(θ\|εᵢ,Z) | sample merge control parameters |
| Eᵢ ← g_{θ}_{ᵢ}(H) | merge candidates into entity records |
| Return E = {E₁,...,Eₘ_{_{λ}}} | |

An example of a procedure for defining relationships between entity records (e.g., conducted at step 304 of method 300 by, for example, a relation program) is as follows:

| Definition | |
|---|---|
| ρᵢ: the i-th relation type in the set of relation types ρ based on λ | |
| Kᵢ: the join key pairs associated with ρᵢ and λ | |
| δᵢ: the search parameters according to Kᵢ | |
| Procedure Relation Program | |
| ρ ← P(ρ\|λ) | sample a set of relation types |
| For i = 1, ... ,n_{λ} do: | |
| Kᵢ ← P(K\|λ, ρᵢ) | sample join keys |
| δᵢ ← P(δ\|Kᵢ) | sample search parameters |
| {(e_{ab},e_{a′b′})} ← s_{δ}_{ᵢ}(E) | generate entity pairs |
| Rᵢ ← {r = {ρᵢ, (e_{ab},e_{a′b′})}} | add relation type to entity pairs |
| Return R = {R₁, ... ,Rₙ_{_{λ}}} | |

An example of a procedure for identifying information from multiple data records and defining entity records from the information (e.g., conducted at step 303 of method 300 by, for example, an entity program) is as follows:

```
Input data source 1:
Crunchbase (Organization)
{
  ″Name″: ″Example Ltd.″,
    ″Founders″: ″John Doe;JB Straubel;Marc Tarpenning;Martin
Eberhard″
}
Facebook(Organization)
{
    ″name″: ″Example Ltd.″
    ″num_likes″: ″12,342 people like this″
}
Wikipedia(Person)
{
    ″name″: ″John Doe″,
  ″birth_place″: ″[[Bronx]], [[New York City]]″,
″ employer″: ″[[Example Ltd.]]″
}
Input data source 2:
Organization (Data Lake)
{
″Id″: ″123″
″Name″: ″Example Ltd.″,
    ″_found″: [456, ″**B Straubel**″]
}
Input data source 3:
Person (Data Lake)
{
  ″Id″: ″456″
    ″Name″: ″John Doe″,
    ″birth_place″: ″The Bronx, New York City ″,
    ″memberOf″: [123]
}
```

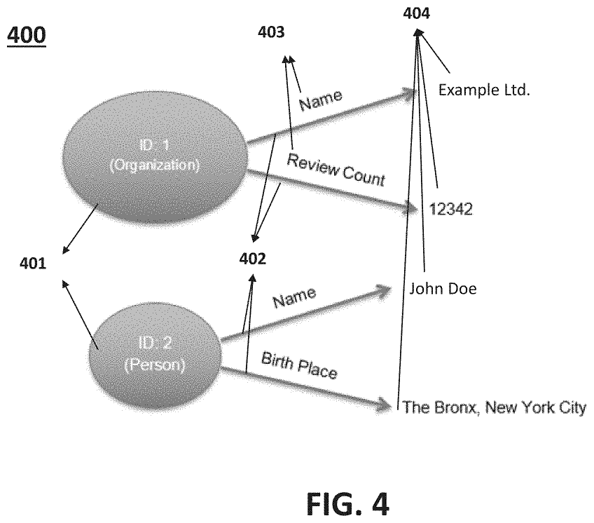

FIG. 4 is a diagram showing an example output from an entity program, according to an embodiment. The diagram 400 is a graphical representation of the output set of entity records of the entity identifier 105 in the knowledge generation device 101. The leftmost ellipsoids 401 represent entity records that can be configured to include an identification number (e.g., 1, 2) and/or an entity type (e.g., organization, person, place, etc.). The rightmost strings 404 are attributes which are identified 402 by using the set of motifs 403 (e.g., name, review count, birth place, and so forth) and the set of control parameters, as disclosed with respect to the knowledge generation device 101. For example, the candidates (also referred to as ‘attribute’ after merging into an entity) 404 ‘Example Ltd.’ and ‘12342’ are identified 402 using, respectively, the motifs 403 ‘Name’ and ‘Review Count’, to merge into the entity record 401 with ID of ‘1’ and an entity type ‘Organization’.

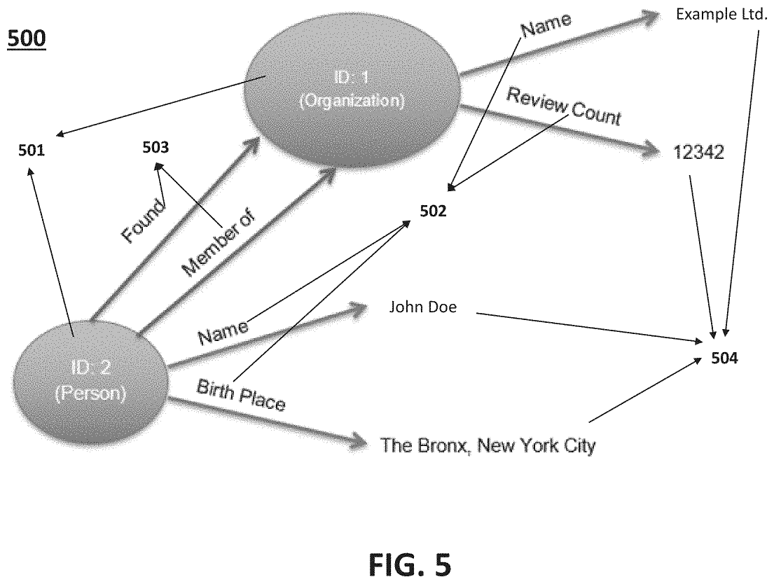

FIG. 5 is a diagram showing an example output from a relationship identifier, according to an embodiment. The diagram 500 is a graphical representation of the output set of entity records of the entity identifier 105 and the output set of relationships of the relationship identifier 114 in the knowledge generation device 101 described with respect to FIG. 1. The ellipsoids 501 represent entity records that can be configured to include an identification number and/or an entity type. The rightmost strings 504 are attributes that are identified by using the set of motifs 502 and using the set of control parameters, as disclosed with respect to the knowledge generation device 101. The relationship identifier can be configured to link the entity records 501 using relation types 503. In an example, the attributes 504 ‘John Doe’ and ‘The Bronx, New York City’ are identified using the motifs 502 ‘Name’ and ‘Birth City’ to merge into the entity record 501 with ID of ‘2’ and an entity type of ‘Person’. Also in the example, the attributes 504 ‘Example Ltd.’ and ‘12342’ are identified using the motifs 502 ‘Name’ and ‘Review Count’ to merge into the entity record 501 with ID of ‘1’ and an entity type of ‘Organization’. Also in the example, the entity records with the IDs of ‘1’ and ‘2’ are linked together with the relation types of ‘Founder’ and ‘Member of’.

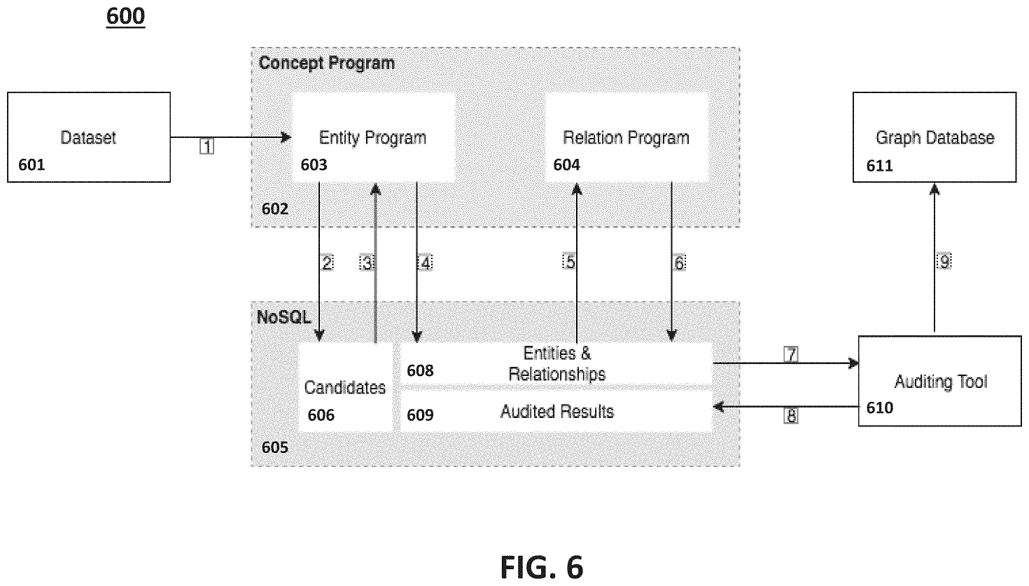

FIG. 6 is a diagram showing a system 600 for generating a knowledge graph data structure 611, according to an embodiment. The system 600 can be part of a knowledge generation device 101 described with respect to FIG. 1. The system 600 can be the same as or substantially similar to the knowledge generation device 101 described with respect to FIG. 1. For example, the system 600 can include a dataset 601, a concept program 602, a NoSQL database 605, an auditing tool 610, and a graph database 611.

The concept program 602 can include an entity program 603 and a relation program 604, and can be configured to receive, via step 1, the dataset 601 to process the dataset, at the processor 104 described with respect to FIG. 1, and to store, via step 2, 4, and/or 6, the processed dataset to the NoSQL database 605. The entity program 603 can be configured to directly receive, via step 1, the dataset 601 and generate a set of candidates 606 to be stored in the NoSQL database 605, via step 2. The set of candidates 606 can be received, via step 3, by the entity program 603 again to generate, by applying merging rules, a set of entity records 608 to be stored, via step 4, in the NoSQL database 605. In an embodiment, the set of entity records 608 can be received, via step 5, at the relation program 604 to generate a set of relationships 608 to be stored, via step 6, in the NoSQL database 605. The set of entity records and the set of relationships 608, stored at the NoSQL database 605 can be operatively coupled, via step 7 and/or 8, to an auditing tool 610 to verify the data stored in the NoSQL database 605. The graph database 611 receives, via step 9, a verified set of entity records and the set of relationships that pass the verification step of the auditing tool 610. A graphical representation of the graph database 611 can be then used to generate a knowledge graph data structure to be presented to a potential user.

The auditing tool 610 can be configured to read the set of entity records and the set of relationships, generated, respectively, by the entity program 603, and the relation program 604, and stored in the NoSQL database 605. The auditing tool 610 can be configured further to verify the correctness of the set of entity records and the set of relationships and store the feedback of that verification in the NoSQL database 605. The auditing tool 610 can be operated by at least one user and/or by at least one automated program.

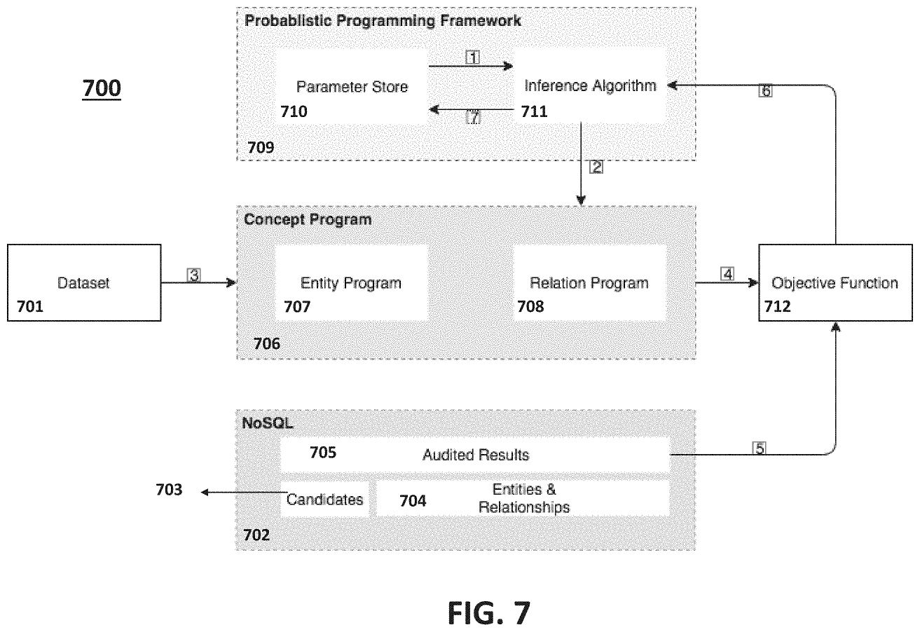

FIG. 7 is a diagram showing a system 700 for generating a knowledge graph data structure, according to an embodiment. The system 700 can, for example, be part of a knowledge generation device 101 described with respect to FIG. 1. The system 700 can be the same as or substantially similar to the knowledge generation device 101 described with respect to FIG. 1. For example, in an embodiment, the system 700 can receive, via step 3, a dataset 701, a concept program 706, a NoSQL database 703, a probabilistic programming framework 709, and an objective function 712.

In an embodiment, the probabilistic programming framework 709 can include a parameter store 710 and an inference algorithm 711. A set of model parameters can be stored, via step 7, in the parameter store 710 and can be read, via step 1, by the inference algorithm 711. The set of model parameters can be, for example, parameters from at least one previously trained BPL model. The parameter store and the inference algorithm can be stored, for example, in the memory 102 described with respect to FIG. 1. The concept program 706 can include an entity program 707 and a relation program 708, and can be configured to receive, via step 3, the set of model parameters, and to store the processed dataset to the NoSQL database 703. The NoSQL database can include a set of candidates 703, a set of entity records 704, and a set of relationships 704, and a set of audited results 705 stored beforehand in the NoSQL database 702. The set of model parameters can be configured to trigger to execute the concept program 706 to receive, via step 3, the dataset 701. The concept program can be configured to generate a set of predicted entity records and a set of predicted relationships in the same way or in a substantially similar way to the concept program 602 described with respect to FIG. 6. At least one of the set of predicted entity records, the set of predicted relationships, or the set of audited results are received, via steps 4, 5, and/or 6, by the objective function 712. The objective function 712 can be configured to find, by optimizing the value of a loss function for the inference algorithm 711, a set of optimal and/or improved model parameters. The set of optimal and/or improved model parameters can be a set of empirical distributions with a determined likelihood of correctness. The set of optimal and/or improved model parameters can be stored in the parameter store 710 to update the set of model parameters. The process described with respect to FIG. 7 can be iterated until optimization and/or sufficient improvement of the value of the loss function for the inference algorithm 711 converges to a predetermined threshold.

The system 700 can use optimization algorithms, for example, Markov chain Monte Carlo (MCMC), variational inference, or the like, to optimize, with respect to the objective function 712, the information extractor 108, the candidate merger 112, and/or the search function 117, shown and described with respect to FIG. 1. The objective function 712 is defined by a loss function that calculates, for example, mean squared error, Kullback-Leibler divergence, and/or the like, over the predicted set of entity records, the predicted set of relationships, and audited results. As such, the learning procedure of, for example, the system 709 is implemented over a probabilistic programming framework 709 that provides the inference algorithms 711 with regard to an objective function 712. For example, in MCMC optimization, for example, two pairs of candidates can be selected by random (Monte Carlo) to be considered for merging by candidate merger 112. The objective function 712 compares to determine which of the two pairs of candidates has a more favorable likelihood to merge correctly, and selects one of the pairs of candidates and adds a representation of the selected pair to a chain of parameters (Markov Chain).

Some embodiments described herein relate to methods. It should be understood that such methods can be computer implemented methods (e.g., instructions stored in memory and executed on processors). Where methods described above indicate certain events occurring in certain order, the ordering of certain events can be modified. Additionally, certain of the events can be performed repeatedly, concurrently in a parallel process when possible, as well as performed sequentially as described above. Furthermore, certain embodiments can omit one or more described events.

Some embodiments described herein relate to computer-readable medium. A computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) can be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as ASICs, PLDs, ROM and RANI devices. Other embodiments described herein relate to a computer program product, which can include, for example, the instructions and/or computer code discussed herein.

Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, R, Java, C++, or other programming languages (e.g., object-oriented programming languages) and development tools. Additional examples of computer code include, but are not limited to, control signals, encrypted code, and compressed code.

All combinations of the foregoing concepts and additional concepts discussed herewithin (provided such concepts are not mutually inconsistent) are contemplated as being part of the subject matter disclosed herein. The terminology explicitly employed herein that also can appear in any disclosure incorporated by reference should be accorded a meaning most consistent with the particular concepts disclosed herein.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

To address various issues and advance the art, the entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments can be practiced. The advantages and features of the application are of a representative sample of embodiments only, and are not exhaustive and/or exclusive. They are presented to assist in understanding and teach the embodiments.

Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

Various concepts can be embodied as one or more methods, of which at least one example has been provided. The acts performed as part of the method can be ordered in any suitable way. Accordingly, embodiments can be constructed in which acts are performed in an order different than illustrated, which can include performing some acts simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

It should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein can be implemented in a manner that enables a great deal of flexibility and customization as described herein.

All definitions, as defined and used herein, should be understood to control over dictionary definitions, definitions in documents incorporated by reference, and/or ordinary meanings of the defined terms.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes can be made without departing from the scope of the disclosure.

1. A non-transitory processor-readable medium storing code representing instructions to be executed by a processor, the code comprising code to cause the processor to:
extract a plurality of data records from at least one data source;
combine, using a first set of predefined rules having parameters trained using a first Bayesian Program Learning model, a set of data records from the plurality of data records into a single data record based on a likelihood that each data record from the set of data records is associated with a common entity;
define a link between the single data record and at least one other data record from the plurality of data records using a second set of predefined rules having parameters trained using a second Bayesian Program Learning model;
generate a knowledge graph data structure that represents a set of links including the link; and
detect, based on the set of links, a set of attributes associated with the common entity.

2. The non-transitory processor-readable medium of claim 1, wherein the plurality of data records from the at least one data source includes at least one of image data, video data, audio data, textual data, or time series data.

3. The non-transitory processor-readable medium of claim 1, wherein the plurality of data records from the at least one data source includes at least one of structured data, semi-structured data, or unstructured data.

4. The non-transitory processor-readable medium of claim 1, wherein the at least one data source includes at least one of a database, a file system, or an application.

5. The non-transitory processor-readable medium of claim 1, wherein the code to cause the processor to extract is performed by at least one of an artificial neural network (ANN), an isomap, a kernel principal component analysis (kernel PCA), a thresholding, or a connected-component labeling.

6. The non-transitory processor-readable medium of claim 1, the code further comprising code to cause the processor to:
improve the knowledge graph data structure using at least one of a Markov Chain Monte Carlo (MCMC) algorithm or a variational inference algorithm.

7. A method, comprising:
receiving a plurality of data records, the plurality of data records being heterogeneous data from at least one data source, the heterogeneous data from the at least one data source including at least one of structured data, semi-structured data, or unstructured data;
preparing the plurality of data records using feature extraction and normalization to generate a plurality of prepared data records;
defining a plurality of entity records, each entity record from the plurality of entity records defined by sampling data from an empirical distribution of the plurality of prepared data records and merging a first prepared data record from the plurality of prepared data records with a second prepared data record from the plurality of prepared data records based on comparing the sampled data with a set of predefined quality criteria;
associating each entity record of an entity record pair from a plurality of entity record pairs from the plurality of entity records with a remaining entity record from that entity record pair to generate a plurality of relationships based on an indication of relation type and an indication of relation likelihood for each entity record pair from the plurality of entity record pairs; and
generating a knowledge graph data structure based on the plurality of entity records and the plurality of relationships.

8. The method of claim 7, wherein the heterogeneous data from the at least one data source includes at least one of image data, video data, audio data, a textual data, or time series data.

9. The method of claim 7, wherein the at least one data source includes at least one of a database, a file system, or an application.

10. The method of claim 7, wherein the feature extraction is performed by at least one of an artificial neural network (ANN), an isomap, a kernel principal component analysis (kernel PCA), a thresholding, or a connected-component labeling.

11. The method of claim 7, wherein the set of predefined quality criteria includes at least one of a merge key to compare with the plurality of prepared data records, a confidence level of the plurality of prepared data records, or a threshold of similarity of the plurality of prepared data records.

12. The method of claim 7, further comprising:
improving the knowledge graph data structure using at least one of a Markov Chain Monte Carlo (MCMC) algorithm or a variational inference algorithm.

13. The method of claim 7, wherein the indication of relation type and the indication of relation likelihood for each entity record pair from the plurality of entity record pairs are a normalized numerical value.

14. An apparatus, comprising:
a memory; and
a processor operatively coupled to the memory,
the processor configured to receive a plurality of data records, the plurality of data records being heterogeneous data from at least one data source,
the processor configured to prepare the plurality of data records using feature extraction and normalization to generate a plurality of prepared data records,
the processor configured to define each entity record from a plurality of entity records by merging a first prepared data record from the plurality of prepared data records with a second prepared data record from the plurality of prepared data records,
the processor configured to associate each entity record of an entity record pair from a plurality of entity record pairs from the plurality of entity records with a remaining entity record from that entity record pair to generate a plurality of relationships, each entity record pair from the plurality of entity record pairs having an indication of relation type and an indication of relation likelihood, and
the processor configured to generate a knowledge graph data structure based on the plurality of entity records and the plurality of relationships.

15. The apparatus of claim 14, wherein the heterogeneous data from the at least one data source includes at least one of structured data, semi-structured data, or unstructured data.

16. The apparatus of claim 14, wherein the at least one data source includes at least one of a database, a file system, or an application.

17. The apparatus of claim 14, wherein the feature extraction is performed by at least one of an artificial neural network (ANN), an isomap, a kernel principal component analysis (kernel PCA), a thresholding, or a connected-component labeling.

18. The apparatus of claim 14, wherein the processor is configured to perform an automated process on the knowledge graph data structure including:
identifying at least one new relationship;
updating the plurality of relationships to include the at least one new relationship to define a plurality of updated relationships; and
regenerating the knowledge graph data structure based on the plurality of updated relationships.

19. The apparatus of claim 14, wherein the processor is configured to improve the knowledge graph data structure using at least one of a Markov Chain Monte Carlo (MCMC) algorithm or a variational inference algorithm.

20. The apparatus of claim 14, wherein the processor is configured define each entity record from the plurality of entity records by sampling data from an empirical distribution of the plurality of prepared data records and merging the first prepared data record from the plurality of prepared data records with the second prepared data record from the plurality of prepared data records based on comparing the sampled data with a set of predefined quality criteria.
